(19) United States
(12) Patent Application Publication
(10) Pub. No.: US 2025/0158883 A1
(43) Pub. Date: May 15, 2025

(54) Method and System to Manage and Discover Network Elements to Optimize Energy Utilization in IP-based Networks

(71) Applicant: Cisco Technology, Inc., San Jose, CA (US)

(72) Inventors: Ammar Rayes, SAN JOSE, CA (US); Balaji R. Venkatraman, SAN JOSE, CA (US); Samer M. Salam, BEIRUT (LB)

(21) Appl. No.: 18/509,830

(22) Filed: Nov. 15, 2023

(51) Int. Cl. H04L 41/0823; H04L 41/0893; H04L 41/0894

(52) U.S. Cl. CPC H04L 41/0823; H04L 41/0893; H04L 41/0894

(57) ABSTRACT

Devices, networks, systems, methods, and processes for optimizing the energy consumption of a communication network are described herein. A network optimizer can group multiple network devices in the communication network into one or more energy management groups. The network optimizer may optimize an energy consumption of the one or more energy management groups by generating and transmitting one or more energy optimization configurations. The network optimizer can generate a device replacement list for an energy management group to suggest one or more replacement devices for every replaceable device that is not capable of implementing an energy optimization function. The network optimizer may provide an interactive dashboard and may further facilitate a network operator to modify the energy management groups through the interactive dashboard. The network optimizer can monitor and control the energy consumption of the energy management groups dynamically, thereby resulting into reduction in the energy consumption of the communication network.

The present disclosure relates to communication networks. More particularly, the present disclosure relates to optimizing energy utilization of network devices in the communication networks.

### BACKGROUND

A communication network includes various network devices of different types that are configured to perform specific functions of the communication network. Evaluating the sustainability of the communication network involves the assessment of various energy parameters associated with these network devices. Examples of the energy parameters include energy consumption of the network devices, power saving modes of the network devices, or energy star ratings of the network devices, for example. However, these energy parameters are often not readily accessible and must be obtained from the network devices after the network devices capture the energy parameters.

The energy parameters of the network devices may depend on the hardware, firmware, or software of the network devices. For instance, some legacy devices can be capable of capturing the energy parameters, but may not be capable of reporting the energy parameters, whereas some other legacy devices may not be capable of capturing any energy parameters. Further, some legacy devices, although capable of capturing and reporting the energy parameters, may not be capable of operating in a saving power-saving mode. Furthermore, some other legacy devices can be capable of operating in the power-saving mode, but should not be operated in the power-saving mode if these legacy devices implement critical functions that are essential for uninterrupted connectivity within the communication network. Therefore, conventional sustainability techniques or conventional network optimization techniques that solely rely on the energy parameters of the network devices to operate the network devices in the power-saving mode may cause interruptions in the connectivity within the communication network.

Moreover, different types of network devices may report the energy parameters in different formats and at different time intervals. Such inconsistencies in reporting the energy parameters may be caused due to the differences in the hardware, firmware, or software of the network devices. Utilizing such inconsistent energy parameters for evaluating the sustainability of the communication network may result in erroneous conclusions. Hence, various challenges are posed in evaluating the sustainability of the communication network in an accurate and reliable manner. Therefore, there is a need for a technique to reliably and accurately evaluate the sustainability of the network devices and to optimize the communication network without affecting the uninterrupted connectivity within the communication network.

### SUMMARY OF THE DISCLOSURE

Systems and methods that optimize a communication network in accordance with embodiments of the disclosure are described herein. In some embodiments, a device includes a processor, a memory communicatively coupled to the processor, and a network optimization logic that is configured to discover a plurality of network devices in a network, determine a plurality of device parameters corresponding to the plurality of network devices, retrieve device placement data indicative of placements of the plurality of network devices within the network, group a first set of network devices of the plurality of network devices into a first energy management group based on the device placement data and a first set of device parameters of the plurality of device parameters corresponding to the first set of network devices, and determine an energy optimization configuration for the first energy management group.

In some embodiments, the network optimization logic is further configured to transmit the energy optimization configuration to the first set of network devices in the first energy management group.

In some embodiments, the network optimization logic is further configured to discover the plurality of network devices or transmit the energy optimization configuration to the first set of network devices by utilizing one or more network automation protocols.

In some embodiments, the energy optimization configuration is indicative of one or more power down times and one or more wake-up times.

In some embodiments, the first set of network devices switch off at the one or more power down times indicated by the energy optimization configuration, and wherein the first set of network devices switch on at the one or more wake-up times indicated by the energy optimization configuration.

In some embodiments, the network optimization logic is further configured to retrieve historical usage data for the first set of network devices, and generate the energy optimization configuration based on the historical usage data.

In some embodiments, the network optimization logic is further configured to group a second set of network devices of the plurality of network devices into a second energy management group based on the device placement data and a second set of device parameters of the plurality of device parameters corresponding to the second set of network devices.

In some embodiments, the network optimization logic is further configured to determine an operational configuration of the second set of network devices, and generate a device replacement list for the second energy management group based on the operational configuration of the second set of network devices.

In some embodiments, the device replacement list includes one or more replacement devices corresponding to each network device of the second set of network devices.

In some embodiments, a device further includes a display.

In some embodiments, the network optimization logic is further configured to generate an interactive dashboard indicative of the energy optimization configuration and the device replacement list, and display the interactive dashboard on the display.

In some embodiments, the network optimization logic is further configured to determine one or more critical network devices of the plurality of network devices based on the plurality of device parameters and the device placement data, and exclude the one or more critical network devices from the first energy management group or the second energy management group.

In some embodiments, the plurality of device parameters include one or more of device identifiers of the plurality of network devices, software versions of the plurality of network devices, or power-saving capabilities of the plurality of network devices.

In some embodiments, the plurality of device parameters and the device placement data are stored in corresponding plurality of network devices.

In some embodiments, the plurality of device parameters and the device placement data are stored in a storage device in the network.

In some embodiments, a method includes discovering a plurality of network devices in a network, determining a plurality of device parameters corresponding to the plurality of network devices, retrieving device placement data indicative of placements of the plurality of network devices in the network, grouping one or more network devices of the plurality of network devices into an energy management group based on the device placement data and one or more device parameters of the plurality of device parameters corresponding to the one or more network devices, and determining an energy optimization configuration for the energy management group.

In some embodiments, a network optimization logic is configured to discover a plurality of network devices in a network, determine a plurality of device parameters corresponding to the plurality of network devices, retrieve device placement data indicative of placements of the plurality of network devices in the network, group one more network devices of the plurality of network devices into one or more energy management groups based on the device placement data and the plurality of device parameters, and determine one or more energy optimization configurations corresponding to the one or more energy management groups.

In some embodiments, the network optimization logic is further configured to transmit the one or more energy optimization configurations to the one or more energy management groups respectively.

In some embodiments, the network optimization logic is further configured to retrieve historical usage data for an energy management group of the one or more energy management groups, generate a power down schedule for the energy management group based on the historical usage data, and transmit the power down schedule to the energy management group.

In some embodiments, the network optimization logic is further configured to determine an operational configuration of an energy management group of the one or more energy management groups, and generate a device replacement list for the energy management group based on the operational configuration of the energy management group.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of a communication network including a plurality of energy management groups, in accordance with various embodiments of the disclosure;

FIG. 2 is a conceptual illustration of critical network devices or legacy devices in a plurality of energy management groups in a communication network, in accordance with various embodiments of the disclosure;

FIG. 3 is a conceptual network diagram of various environments that a network optimizer that may operate on a plurality of network devices, in accordance with various embodiments of the disclosure;

FIG. 4 is a flowchart depicting a process for grouping one or more network devices in a network, in accordance with various embodiments of the disclosure;

FIG. 5 is a flowchart depicting a process for optimizing one or more energy management groups in a network, in accordance with various embodiments of the disclosure;

FIG. 6 is a flowchart depicting a process for displaying an interactive dashboard, in accordance with various embodiments of the disclosure;

FIG. 7 is a flowchart depicting a process for optimizing a network, in accordance with various embodiments of the disclosure;

FIG. 8 is a graph for an elbow selection criteria for network optimization, in accordance with various embodiments of the disclosure; and

FIG. 9 is a conceptual block diagram of a device suitable for configuration with a network optimization logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that optimize a communication network. In a communication network, a network optimizer may discover a plurality of network devices in the communication network. The network optimizer can discover the network devices in the communication network by utilizing one or more network automation protocols. The network automation protocols may include Cisco Discovery Protocol (CDP), Network Configuration Protocol (NETCONF), or Simple Network Management Protocol (SNMP), for example. In some embodiments, the network optimizer may be implemented by way of a network optimization logic in a network device in the communication network. In certain embodiments, the network optimizer can be a controller within the communication network or external to the communication network. The network optimizer may determine a plurality of device parameters corresponding to the network devices. Examples of the device parameters may include device identifiers of the network devices, software versions of the network devices, or power-saving capabilities or operational modes of the network devices, for example. In more embodiments, the device parameters can be stored in the corresponding network devices. In some more embodiments, the device parameters can be stored in a storage device in the communication network. The network optimizer may further retrieve device placement data indicative of placements of the network devices in the communication network. In numerous embodiments, the device placement data may be stored in one or more network devices. In many further embodiments, the device placement data can be stored in the storage device in the communication network. The network optimizer can group a first set of network devices into a first energy management group based on the device placement data and a first set of device parameters of the plurality of device parameters corresponding to the first set of network devices. The network optimizer may determine an energy optimization configuration for the first energy management group. In still more embodiments, the energy optimization configuration can include one or more power down times and one or more wake-up times for the first set of network devices. In further embodiments, the energy optimization configuration can include one or more power-saving mode times for the first set of network devices. In additional embodiments, the energy optimization configuration may include a power down schedule for the first set of network devices.

In many embodiments, the network optimizer may transmit the energy optimization configuration to the first set of network devices in the first energy management group. In some embodiments, the network optimizer can utilize the network automation protocols for transmitting the energy optimization configuration to the first set of network devices. In certain embodiments, the network optimizer can transmit the energy optimization configuration by transmitting one or more control signals to the first set of network devices. In more embodiments, the network optimizer may transmit control data indicative of the energy optimization configuration on a control channel. The first set of network devices can receive the energy optimization configuration and then implement the energy optimization configuration in the first energy management group. In that, the first set of network devices may switch off at the one or more power down times indicated by the energy optimization configuration. In some more embodiments, the first set of network devices may switch into a power-saving mode at the one or more power-saving mode times indicated by the energy optimization configuration. Thereafter, the first set of network devices may further switch on at the one or more wake-up times indicated by the energy optimization configuration. In numerous embodiments, the first set of network devices may include the network devices that are capable of implementing one or more energy optimization functions and are qualified to implement the energy optimization functions. In many further embodiments, the first set of network devices can include the network devices that are not critical to maintain uninterrupted connectivity within the communication network.

In a number of embodiments, the network optimizer can retrieve historical usage data for the first set of network devices. In some embodiments, the historical usage data can be stored in the corresponding network devices. In certain embodiments, the historical usage data can be stored in the storage device in the communication network. In more embodiments, the historical usage data may include device uptime, bandwidth usage, network traffic patterns, device configuration changes, user activity, energy consumption, Quality of Service (QOS), or device fault logs of the first set of network devices, for example. The network optimizer may generate the energy optimization configuration based on the historical usage data.

In various embodiments, the network optimizer may group a second set of network devices of the plurality of network devices into a second energy management group based on the device placement data and a second set of device parameters of the plurality of device parameters corresponding to the second set of network devices. The network optimizer can determine an operational configuration of the second set of network devices. In some embodiments, the operational configuration may include routing protocols, access control lists, QoS, Virtual Local Area Network (VLAN) setups, firewall configurations, Wireless Access Point (WAP) configurations, traffic balancing configurations, for example. In certain embodiments, the operational parameters may include power consumption characteristics, device identifiers, device health, or device security for example. Further, the network optimizer may generate a device replacement list for the second energy management group based on the operational configuration of the second set of network devices. The device replacement list can include one or more replacement devices corresponding to each network device of the second set of network devices. In more embodiments, the second set of network devices may include one or more legacy devices that are not capable of implementing the energy optimization functions. In some more embodiments, the second set of network devices can include the network devices that are not qualified to implement the energy optimization functions. In numerous embodiments, the second set of network devices may include one or more critical network devices that are essential to maintain the uninterrupted connectivity within the communication network.

In additional embodiments, the network optimizer can generate an interactive dashboard indicative of the energy optimization configuration and the device replacement list. In some embodiments, the network optimizer may display the interactive dashboard on a display of the controller. In certain embodiments, the network optimizer can display the interactive dashboard on one or more displays of one or more network devices in the communication network. In more embodiments, the interactive dashboard can facilitate a network operator to change or modify the energy optimization configurations of the energy management groups. In some more embodiments, the interactive dashboard may also display the historical energy consumption of the network, the present energy consumption of the network, or projected energy savings based on the energy optimization configurations, for example. In numerous embodiments, the interactive dashboard may also display the energy management groups and the network devices in the energy management groups, for example. In many further embodiments, the interactive dashboard can further display the operational configurations of the network devices, the placements of the network devices in the communication network, or the placements of the energy management groups in the communication network, for example.

In further embodiments, the network optimizer may determine one or more critical network devices of the plurality of network devices based on the plurality of device parameters and the device placement data. In some embodiments, the network optimizer can exclude the critical network devices from the first energy management group or the second energy management group. In certain embodiments, the network optimizer may exclude the critical network devices from the first energy management group but retain the critical network devices in the second energy management group. In more embodiments, if one of the critical network devices is a legacy device, the network optimizer can determine a replacement device for the critical network device. In some more embodiments, the critical devices may be essential to maintain the uninterrupted connectivity in the communication network.

In many more embodiments, the network optimizer may use Artificial Intelligence (AI) or Machine Learning (ML) techniques to optimize the grouping of the network devices to form the energy management groups. The network optimizer can dynamically assign or re-assign the network devices in the energy management groups based on the AI/ML techniques. The network optimizer may also determine the optimum sizes of the energy management groups based on the AI/ML techniques. The network optimizer is not limited to any particular grouping technique, and hence, the network optimizer may use alternative grouping techniques to form energy management groups based on AI/ML techniques. The network optimizer can also dynamically change the energy management groups based on changes in the communication network, such as, addition of new network devices, removal of existing network devices, replacement of any network device, functional change of any network device, for example.

Advantageously, the network optimizer can optimize the energy consumption of the communication network. The network optimizer can also identify and manage critical network devices such that the uninterrupted connectivity within the communication network is not affected. The network optimizer provides a significant reduction in the energy consumed by the communication network. Since the network optimizer facilitates the optimization of the communication network by way of grouping the network devices, difficulties in optimizing each network device individually are eliminated. By using the AI/ML techniques, the network optimizer can react or adapt to the dynamic changes in the communication network by dynamically modifying the energy management groups. The network optimizer can further dynamically change the energy optimization configuration based on the changes to the energy management groups.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

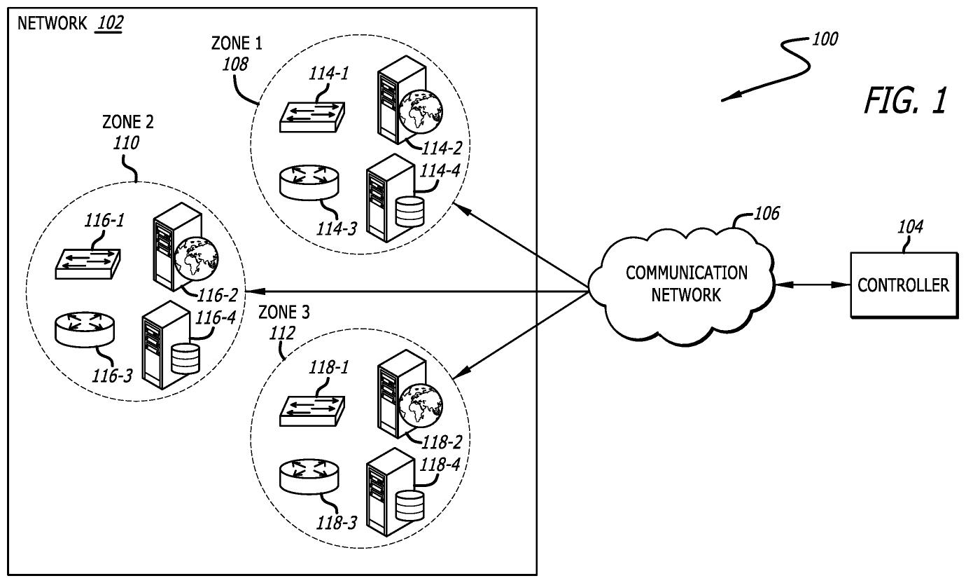

Referring to FIG. 1, a conceptual illustration of a communication network 100 including a plurality of energy management groups, in accordance with various embodiments of the disclosure is shown. The communication network 100 may include a network 102 in communication with a controller 104 by way of a wired or wireless communication network such as Internet 106. The network 102 can include a first energy management group 108, a second energy management group 110, and a third energy management group 112. The first through third energy management groups 108-112 may be connected to the internet 106. The first energy management group 108 may include a first switch 114-1, a first server 114-2, a first router 114-3, and a first database 114-4, for example (also referred to as the first set of network devices 114). The second energy management group 110 can include a second switch 116-1, a second server 116-2, a second router 116-3, and a second database 116-4, for example (also referred to as the second set of network devices 116). The third energy management group 112 may include a third switch 118-1, a third server 118-2, a third router 118-3, and a third database 118-4, for example (also referred to as the third set of network devices 118). The first energy management group 108 may be located in a first place or a first zone (Zone 1) in the network 102, for example. The second energy management group 110 may be located in a second place or a second zone (Zone 2) in the network 102, for example. The third energy management group 112 may be located in a third place or a third zone (Zone 3) in the network 102, for example.

In many embodiments, the controller 104 may implement a network optimization logic. The controller 104 can discover the network devices 114-118 by utilizing one or more network automation protocols. The controller 104 may determine one or more device parameters corresponding to the network devices 114-118. The controller 104 may retrieve device placement data indicative of placements of the network devices 114-118 in the network 102. The controller 104 can group the first set of network devices 114 to form the first energy management group 108, the controller 104 can group the second set of network devices 116 to form the second energy management group 110, and the controller 104 can group the third set of network devices 118 to form the third energy management group 112.

In a number of embodiments, the controller 104 can determine a first energy optimization configuration for the first energy management group 108 based on the device placement data and a first set of device parameters corresponding to the first set of network devices 114. The controller 104 may determine a second energy optimization configuration for the second energy management group 110 based on the device placement data and a second set of device parameters corresponding to the second set of network devices 116. The controller 104 may determine the operational configurations of the third set of network devices 118. Further, the controller 104 may generate a device replacement list for the third energy management group 112 based on the operational configurations of the third set of network devices 118 and the device placement data.

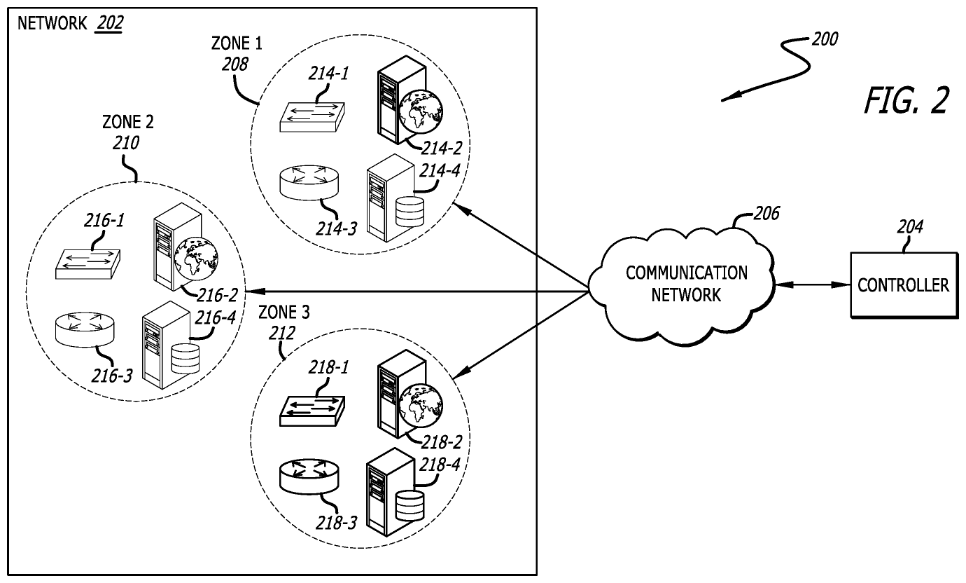

Although a specific embodiment for the communication network 100 for carrying out the various steps, processes, methods, and operations described herein is discussed concerning FIG. 1, any of a variety of systems and/or processes may be utilized by embodiments of the disclosure. For example, the controller 104 may be within the communication network 100, or the network optimization logic can be implemented in the controller 104 or in any of the network devices 114-118. The elements depicted in FIG. 1 may also be interchangeable with other elements of FIGS. 2-9 as required to realize a particularly desired embodiment.

Referring to FIG. 2, a conceptual illustration of critical network devices or legacy devices in a plurality of energy management groups in a communication network 200, in accordance with various embodiments of the disclosure is shown. The communication network 200 may include a network 202 in communication with a controller 204 by way of a wired or wireless communication network such as Internet 206. The network 202 can include a first energy management group 208, a second energy management group 210, and a third energy management group 212. The first through third energy management groups 208-212 may be connected to the internet 206. The first energy management group 208 may include a first switch 214-1, a first server 214-2, a first router 214-3, and a first database 214-4, for example (also referred to as the first set of network devices 214). The second energy management group 210 can include a second switch 216-1, a second server 216-2, a second router 216-3, and a second database 216-4, for example (also referred to as the second set of network devices 216). The third energy management group 212 may include a third switch 218-1, a third server 218-2, a third router 218-3, and a third database 218-4, for example (also referred to as the third set of network devices 218). The first energy management group 208 may be located in a first place or a first zone (Zone 1) in the network 202, for example. The second energy management group 210 may be located in a second place or a second zone (Zone 2) in the network 202, for example. The third energy management group 212 may be located in a third place or a third zone (Zone 3) in the network 202, for example.

In many embodiments, the controller 204 may transmit a first energy optimization configuration to the first energy management group 208 and a second energy optimization configuration to the second energy management group 210. The first energy optimization configuration and the second energy optimization configuration may include one or more power down times and one or more wake-up times for the first set of network devices 214 and the second set of network devices 216 respectively. The first energy optimization configuration and the second energy optimization configuration can also include one or more power-saving mode times for the first set of network devices 214 and the second set of network devices 216 respectively. The first energy optimization configuration and the second energy optimization configuration may include a first power down schedule and a second power down schedule for the first set of network devices 214 and the second set of network devices 216 respectively.

In a number of embodiments, the first set of network devices 214 and the second set of network devices 216 can switch off at the power down times indicated by the first energy optimization configuration and the second energy optimization configuration respectively. The first set of network devices 214 and the second set of network devices 216 may also switch to a power saving mode at the power-saving mode times indicated by the first energy optimization configuration and the second energy optimization configuration respectively. Thereafter, the first set of network devices 214 and the second set of network devices 216 can switch on at the wake-up times indicated by the first energy optimization configuration and the second energy optimization configuration respectively. In some embodiments, the first set of network devices 214 and the second set of network devices 216 can switch on and/or switch off based on the first power down schedule and the second power down schedule respectively.

In various embodiments, the controller 204 may determine that the first server 214-2 is a critical network device. If the controller 204 determines that the first server 214-2 is the critical network device, the controller 204 can exclude the first server 214-2 from the first energy management group 208. In that case, the first server 214-2 may stay operational while the other network devices 214-1, 214-3, and 214-4 in the first energy management group 208 are switched off or switched to the power saving mode.

In additional embodiments, the controller 204 may determine that the third set of network devices 218 are legacy devices. Alternatively, the controller 204 can determine that the third set of network devices 218 are not capable of implementing energy optimization functions or are not qualified to implement the energy optimization functions. In that case, the controller 204 can generate a device replacement list including a replacement device for each network device of the third set of network devices 218.

Although a specific embodiment for the communication network 200 for carrying out the various steps, processes, methods, and operations described herein is discussed with respect to FIG. 2, any of a variety of systems and/or processes may be utilized in accordance with embodiments of the disclosure. For example, the controller 204 may dynamically modify or change the first through third energy management groups 208-212. The elements depicted in FIG. 2 may also be interchangeable with other elements of FIG. 1 and FIGS. 3-9 as required to realize a particularly desired embodiment.

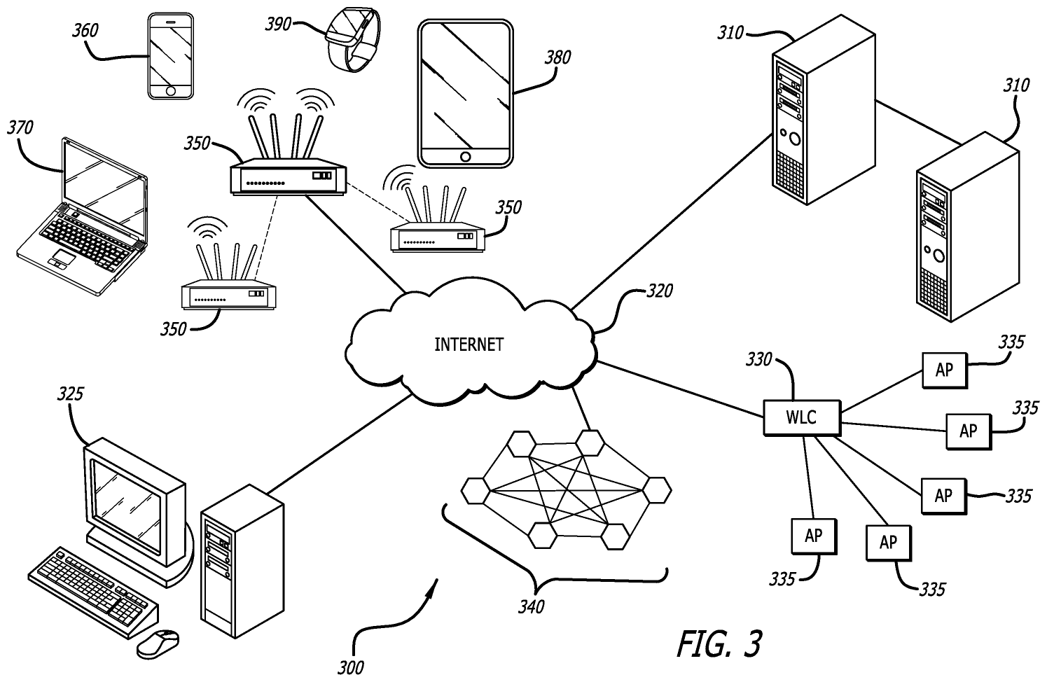

Referring to FIG. 3, a conceptual network diagram 300 of various environments that a network optimizer may operate on a plurality of network devices, in accordance with various embodiments of the disclosure is shown. Those skilled in the art will recognize that the network optimizer can be comprised of various hardware and/or software deployments and can be configured in a variety of ways. In many embodiments, the network optimizer can be configured as a standalone device, exist as a logic in another network device, be distributed among various network devices operating in tandem, or remotely operated as part of a cloud-based network management tool. In further embodiments, one or more servers 310 can be configured with or otherwise operate the network optimizer. In many embodiments, the network optimizer may operate on one or more servers 310 connected to a communication network 320. The communication network 320 can include wired networks or wireless networks. The network optimizer can be provided as a cloud-based service that can service remote networks, such as, but not limited to a deployed network 340. In many embodiments, the network optimizer can be a logic that optimizes the energy consumption of the network 300.

However, in additional embodiments, the network optimizer may be operated as a distributed logic across multiple network devices. In the embodiment depicted in FIG. 3, a plurality of network access points (APs) 350 can operate as the network optimizer in a distributed manner or may have one specific device operate as the network optimizer for all of the neighboring or sibling APs 350. The APs 350 facilitate Wi-Fi connections for various electronic devices, such as but not limited to mobile computing devices including laptop computers 370, cellular phones 360, portable tablet computers 380 and wearable computing devices 390.

In further embodiments, the network optimizer may be integrated within another network device. In the embodiment depicted in FIG. 3, a wireless LAN controller (WLC) 330 may have a network optimizer that the WLC 330 can use to optimize the energy consumption of the various APs 335 that the WLC 330 is connected to, either wired or wirelessly. In still more embodiments, a personal computer 325 may be utilized to access and/or manage various aspects of the network optimizer, either remotely or within the network itself. In the embodiment depicted in FIG. 3, the personal computer 325 communicates over the communication network 320 and can access the network optimizer of the servers 310, or the network APs 350, or the WLC 330.

Although a specific embodiment for various environments that the network optimizer may operate on a plurality of network devices suitable for carrying out the various steps, processes, methods, and operations described herein is discussed with respect to FIG. 3, any of a variety of systems and/or processes may be utilized in accordance with embodiments of the disclosure. In many non-limiting examples, the network optimizer may be provided as a device or software separate from the network devices or the network optimizer may be integrated into one or more network devices. The elements depicted in FIG. 3 may also be interchangeable with other elements of FIGS. 1-2 and 4-9 as required to realize a particularly desired embodiment.

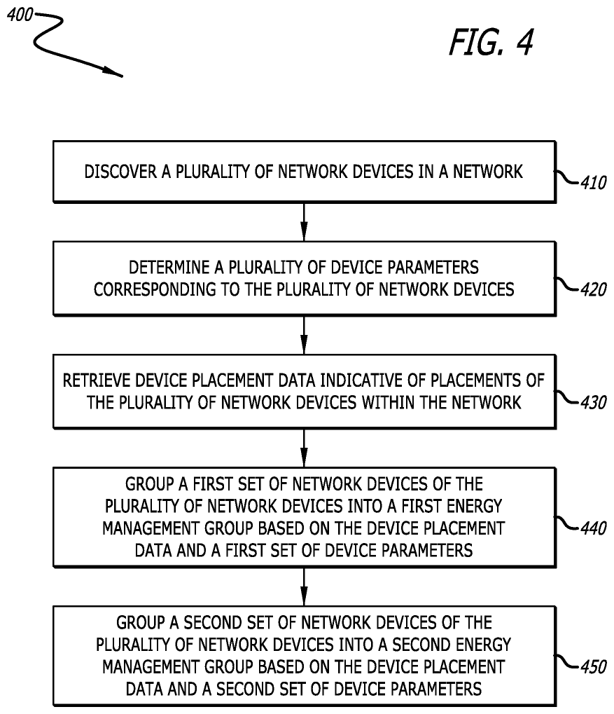

Referring to FIG. 4, a flowchart depicting a process 400 for grouping one or more network devices in a network, in accordance with various embodiments of the disclosure is shown. In many embodiments, the process 400 can discover a plurality of network devices in a network (block 410). In some embodiments, the process 400 may discover the network devices in the network by utilizing one or more network automation protocols. In certain embodiments, the network automation protocols may include Cisco Discovery Protocol (CDP), Network Configuration Protocol (NETCONF), or Simple Network Management Protocol (SNMP), for example. In more embodiments, the process 400 may be implemented by way of a network optimization logic in a network device in the network. In some more embodiments, the process 400 may be implemented by a controller within the network or external to the network.

In a number of embodiments, the process 400 may determine a plurality of device parameters corresponding to the plurality of network devices (block 420). In some embodiments, examples of the device parameters may include device identifiers of the network devices, software versions of the network devices, or power-saving capabilities or operational modes of the network devices, for example. In certain embodiments, the device parameters can be stored in the corresponding network devices. In more embodiments, the device parameters can be stored in a storage device in the network.

In various embodiments, the process 400 can retrieve device placement data indicative of placements of the plurality of network devices within the network (block 430). In some embodiments, the device placement data may be stored in one or more network devices. In certain embodiments, the device placement data can be stored in the storage device in the network. In more embodiments, the device placement data may be indicative of a Place-In-Network (PIN) of the network devices.

In additional embodiments, the process 400 may group a first set of network devices of the plurality of network devices into a first energy management group based on the device placement data and a first set of device parameters (block 440). In some embodiments, the first set of network devices may include the network devices that are capable of implementing one or more energy optimization functions and are qualified to implement the energy optimization functions. In certain embodiments, the first set of network devices can include the network devices that are not critical to maintain the uninterrupted connectivity within the network.

In further embodiments, the process 400 can group a second set of network devices of the plurality of network devices into a second energy management group based on the device placement data and a second set of device parameters (block 450). In some embodiments, the second set of network devices may include one or more legacy devices that are not capable of implementing the energy optimization functions. In certain embodiments, the second set of network devices can include the network devices that are not qualified to implement the energy optimization functions. In more embodiments, the second set of network devices may include one or more critical network devices that are essential to maintain the uninterrupted connectivity within the network.

Although a specific embodiment for a process 400 to group the one or more network devices in the network is described above with respect to FIG. 4, any of a variety of systems and/or processes may be utilized in accordance with embodiments of the disclosure. For example, the process 400 may dynamically modify the first energy management group and the second energy management group. The aspects described in FIG. 4 may also be interchangeable with other elements of FIGS. 1-3 and FIGS. 5-9 as required to realize a particularly desired embodiment.

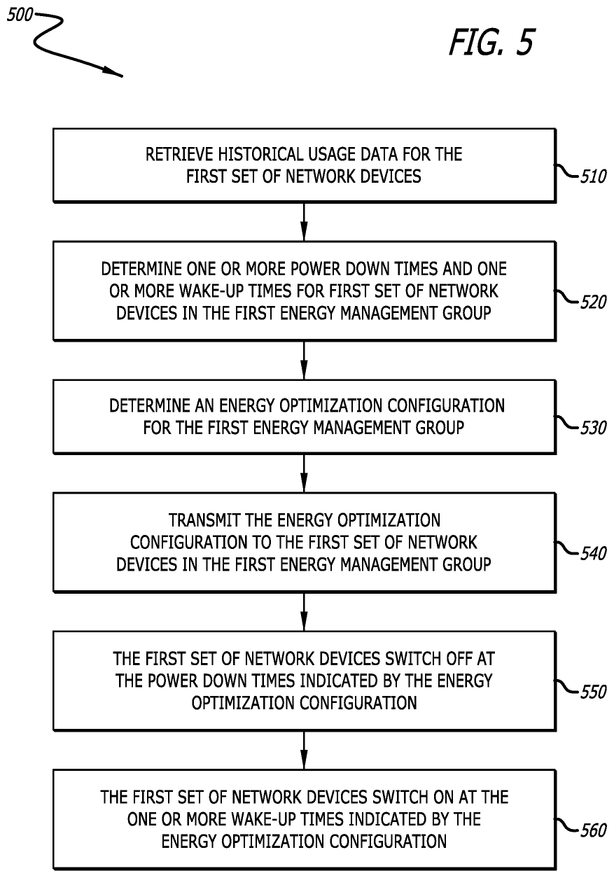

Referring to FIG. 5, a flowchart depicting a process 500 for optimizing one or more energy management groups in the network, in accordance with various embodiments of the disclosure is shown. In many embodiments, the process 500 can retrieve historical usage data for the first set of network devices (block 510). In some embodiments, the historical usage data can be stored in the corresponding network devices. In certain embodiments, the historical usage data can be stored in the storage device in the network. In more embodiments, the historical usage data may include device uptime, bandwidth usage, network traffic patterns, device configuration changes, user activity, energy consumption, QoS, or device fault logs of the first set of network devices, for example.

In a number of embodiments, the process 500 may determine one or more power down times and one or more wake-up times for the first set of network devices in the first energy management group (block 520). In some embodiments, the process 500 may further determine one or more power-saving mode times for the first set of network devices in the first energy management group. In certain embodiments, the process 500 can determine a low-usage duration for the first set of network devices based on the historical usage data indicative of the times when the first set of network devices are not utilized. In more embodiments, the process 500 may determine a start of the low-usage duration as the power down time. In some more embodiments, for example, if the network is a campus network, the first set of network devices may not be used during nights or on weekends. In this case, the process 500 may determine the power down times and the wake-up times such that the first set of network devices are switched off during the nights or on the weekends, thereby reducing the energy consumption of the network.

In a number of embodiments, the process 500 can determine an energy optimization configuration for the first energy management group (block 530). In some embodiments, the energy optimization configuration may include the power down times and the wake-up times for the first set of network devices. In certain embodiments, the energy optimization configuration may include the power-saving mode times for the first set of network devices. In more embodiments, the energy optimization configuration can include a power down schedule for the first set of network devices.

In various embodiments, the process 500 may transmit the energy optimization configuration to the first set of network devices in the first energy management group (block 540). In some embodiments, the process 500 can utilize the network automation protocols for transmitting the energy optimization configuration to the first set of network devices. In certain embodiments, the process 500 can transmit the energy optimization configuration by transmitting one or more control signals to the first set of network devices. In more embodiments, the process 500 may transmit control data indicative of the energy optimization configuration on a control channel.

In additional embodiments, the first set of network devices can switch off at the power down times indicated by the energy optimization configuration (block 550). In some embodiments, the first set of network devices can receive the energy optimization configuration and then implement the energy optimization configuration in the first energy management group. In certain embodiments, the first set of network devices may switch into the power-saving mode at the one or more power-saving mode times indicated by the energy optimization configuration. In more embodiments, the first set of network devices can switch on and/or switch off based on the power down schedule.

In further embodiments, the first set of network devices may switch on at the one or more wake-up times indicated by the energy optimization configuration (block 560). In some embodiments, the first set of network devices can switch from the power-saving mode to the operational mode at the wake-up times indicated by the energy optimization configuration. In more embodiments, the first set of devices can transmit a status signal to the process 500 indicative of switching on or switching to the operational mode. In some more embodiments, one or more ports of the first set of network devices may stay operational to receive one or more control signals from the process 500. In numerous embodiments, the process 500 may transmit a wake-up signal to the first set of network devices to switch on the first set of network devices.

Although a specific embodiment for a process 500 to optimize the one or more energy management groups in the network is described above with respect to FIG. 5, any of a variety of systems and/or processes may be utilized in accordance with embodiments of the disclosure. For example, the process 500 may optimize the energy consumption of the first energy management group by controlling the operational times of the first set of network devices. The aspects described in FIG. 5 may also be interchangeable with other elements of FIGS. 1-4 and FIGS. 6-9 as required to realize a particularly desired embodiment.

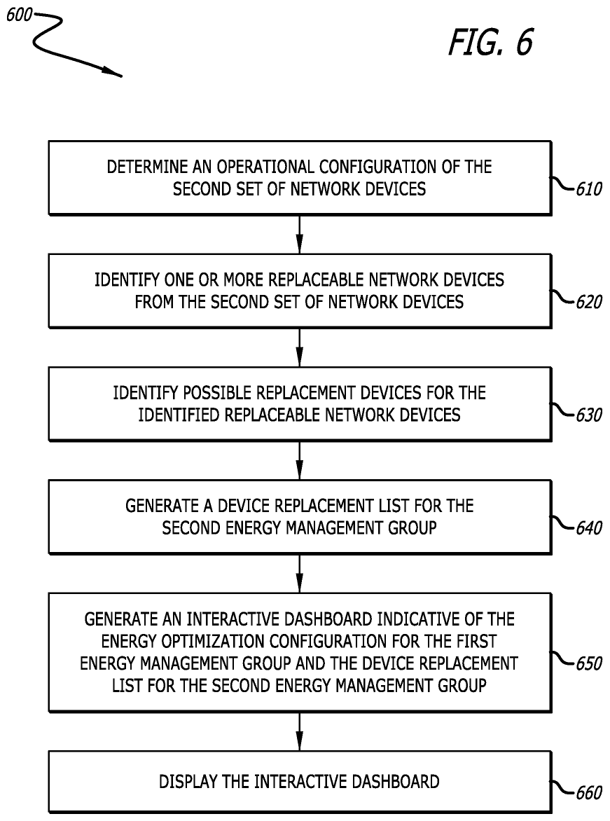

Referring to FIG. 6, a flowchart depicting a process 600 for displaying an interactive dashboard, in accordance with various embodiments of the disclosure is shown. In many embodiments, the process 600 may determine an operational configuration of the second set of network devices (block 610). In some embodiments, the operational configuration may include routing protocols, access control lists, QOS, VLAN setups, firewall configurations, WAP configurations, traffic balancing configurations, for example. In certain embodiments, the operational parameters may include power consumption characteristics, device identifiers, device health, device functions, or device security for example.

In a number of embodiments, the process 600 can identify one or more replaceable network devices from the second set of network devices (block 620). In some embodiments, the process 600 may identify legacy devices or unsupported devices for replacement, for example. In certain embodiments, the process 600 can identify the network devices with old firmware or software for the replacement, for example. In more embodiment, the process 600 may identify the network devices with low energy star rating for the replacement, for example.

In various embodiments, the process 600 may identify possible replacement devices for the identified replaceable network devices (block 630). In some examples, for a legacy device, the process 600 may determine a newer device as the replacement device, for example. In certain examples, for the network devices with low energy star ratings, the process 600 can determine devices with higher energy star rating as the replacement devices, for example. In more embodiments, for the network devices with older firmware or software, the process 600 may determine devices with newer or upgradable firmware or software as the replacement devices, for example.

In additional embodiments, the process 600 can generate a device replacement list for the second energy management group (block 640). In some embodiments, the device replacement list can be stored in the controller. In certain embodiments, the device replacement list can be stored in the storage device in the network. In more embodiments, the device replacement list may include one or more than one replacement devices for each replaceable network device. In some more embodiments, the device replacement list may include priorities for replacing the replaceable network devices. In numerous embodiments, the device replacement list can include one or more predicted energy savings for each replacement device.

In further embodiments, the process 600 may generate an interactive dashboard indicative of the energy optimization configuration for the first energy management group and the device replacement list for the second energy management group (block 650). In some embodiments, the interactive dashboard may include the historical energy consumption of the network, the present energy consumption of the network, or projected energy savings based on the energy optimization configurations, for example. In certain embodiments, the interactive dashboard may also include the energy management groups and the network devices in the energy management groups, for example. In more embodiments, the interactive dashboard can further include the operational configurations of the network devices, the placements of the network devices in the network, or the placements of the energy management groups in the network, for example.

In many more embodiments, the process 600 can display the interactive dashboard (block 660). In some embodiments, the process 600 may display the interactive dashboard on a display of the controller. In certain embodiments, the process 600 can display the interactive dashboard on one or more displays of one or more network devices in the network. In more embodiments, the process 600 may display the interactive dashboard on a remote device as a Software as a service (SaaS). In some more embodiments, the process 600 can facilitate a network operator to change or modify the energy optimization configurations of the energy management groups by way of the interactive dashboard.

Although a specific embodiment for a process 600 to display the interactive dashboard is described above with respect to FIG. 6, any of a variety of systems and/or processes may be utilized in accordance with embodiments of the disclosure. For example, the process 600 may facilitate modifications of the energy management groups by the network operator by way of the interactive dashboard. The aspects described in FIG. 6 may also be interchangeable with other elements of FIGS. 1-5 and FIGS. 7-9 as required to realize a particularly desired embodiment.

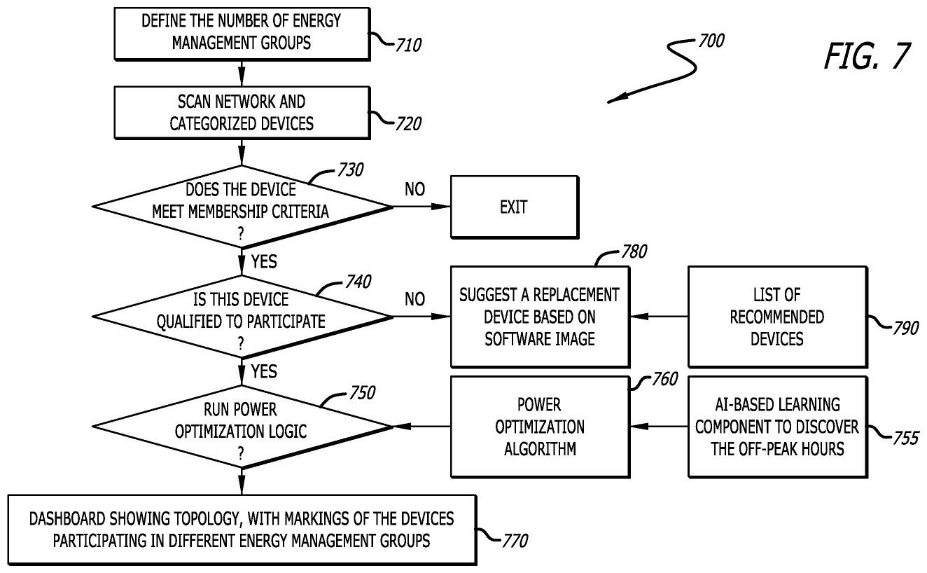

Referring to FIG. 7, a flowchart depicting a process 700 for optimizing the network, in accordance with various embodiments of the disclosure is shown. In many embodiments, the process 700 may define a number of energy management groups (block 710). In some embodiments, the defined energy management groups may include, for example, an Access Points (APs) group, an access switches group, core network devices group, or a Software-Defined Wide Area Network (SD-WAN) group. In certain embodiments, types of the energy management groups and sizes of the energy management groups may depend on the types of the network devices in the network or a number of network devices in the network.

In a number of embodiments, the process 700 can scan the network and categorize the network devices (block 720). In some embodiments, the process 700 may categorize the network devices into one or more categories based on the device parameters or the device placement data or both. In certain embodiments, the process 700 can scan the network using the network automation protocols. In more embodiments, the network automation protocols may include CDP, NETCONF, or SNMP, for example.

In various embodiments, the process 700 may determine if a network device meets membership criteria for any energy management group (block 730). In some embodiments, the process 700 can compare the device parameters of the network device with one or more predefined parameters associated with the defined energy management groups to determine if the network device meets the membership criteria for any energy management group. In certain embodiments, for instance, the critical network devices may meet the membership criteria for the core network devices group. In more embodiments, the process 700 may check whether the network device is capable of implementing the energy optimization functions.

In additional embodiments, if at block 730, the process 700 determines that the network device meets the membership criteria, the process 700 can determine if the network device is qualified to implement the energy optimization functions (block 740). In some embodiments, the legacy devices may not be capable and/or qualified to implement the energy optimization functions. In certain embodiments, the core network devices or the critical network devices may not be qualified to implement the energy optimization functions to ensure uninterrupted connectivity within the network.

In further embodiments, if at block 740, the process 700 determines that the network device is qualified to implement the energy optimization functions, the process 700 can run a power optimization logic or a network optimization logic on the network devices (block 750). In some embodiments, the process 700 may utilize the power optimization logic or the network optimization logic to determine the energy optimization configuration. In certain embodiments, the process 700 may transmit the energy optimization configuration to the network devices. In more embodiments, the network devices may implement the energy optimization configuration.

In many more embodiments, the process 700 may utilize AI/ML learning components to determine off-peak hours for the network devices (block 755). In some embodiments, the process 700 may retrieve the historical usage data for the network devices. In certain embodiments, the process 700 can utilize the AI/ML learning components to process the historical usage data and determine one or more time periods when the network devices are switched off.

In many additional embodiments, the process 700 can utilize a power optimization algorithm to generate the energy optimization configurations (block 760). In some embodiments, the process 700 may utilize the power optimization algorithm to determine the power down times and wake-up times for the network devices. In certain embodiments, the process 700 can utilize the power optimization algorithm to determine power-saving mode times for the network devices. In more embodiments, the power optimization algorithm may utilize an output of the AI/ML learning components to generate the energy optimization configuration.

In many further embodiments, the process 700 may display the interactive dashboard (block 770). In some embodiments, the interactive dashboard may include markings of the network devices participating in the energy management groups. In certain embodiments, the interactive dashboard may include the historical energy consumption of the network, the present energy consumption of the network, or projected energy savings based on the energy optimization configurations, for example. In more embodiments, the process 700 can facilitate the network operator to change or modify the energy optimization configurations of the energy management groups by way of the interactive dashboard.

In still many embodiments, if at block 740, the process 700 determines that the network devices are not qualified to implement the energy optimization functions, the process 700 may suggest one or more replacement devices based on a software image of the network device (block 780). In some embodiments, the process 700 can identify the replaceable network devices. In certain embodiments, the process 700 can identify possible replacement devices for the identified replaceable network devices. In more embodiments, the process 700 may identify the possible replacement devices such that one or more parameters of the software image of the replacement devices are similar or better than one or more parameters of the software image of the replaceable network devices.

In still further embodiments, the process 700 can generate the list of replacement devices (block 790). In some embodiments, the process 700 may display the list of replacement devices in the interactive dashboard. In certain embodiments, the process 700 can store the list of replacement devices in the controller or in the storage device in the network.

Although a specific embodiment for a process 700 to optimize the network is described above with respect to FIG. 7, any of a variety of systems and/or processes may be utilized in accordance with embodiments of the disclosure. For example, the process 700 may control the energy consumption of the energy management groups and thereby reduce the energy consumption of the network. The aspects described in FIG. 7 may also be interchangeable with other elements of FIGS. 1-6 and FIGS. 8-9 as required to realize a particularly desired embodiment.

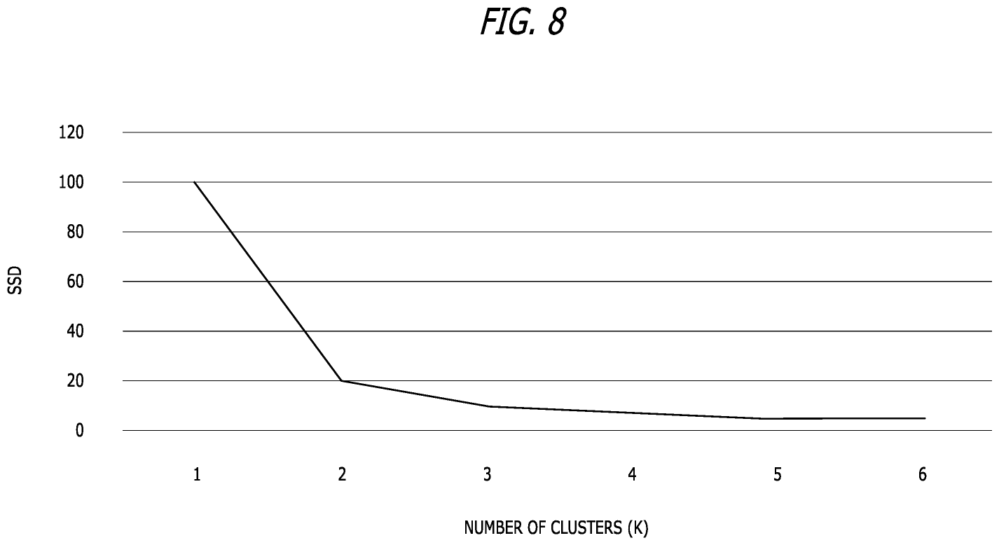

Referring to FIG. 8, a graph for an elbow selection criteria for network optimization, in accordance with various embodiments of the disclosure is shown. In many embodiments, the network optimizer may automatically determine an optimal number of energy management groups based on a number of the network devices in the network, functions of the network devices, or a combination of both. Additionally, the network optimizer may utilize the network automation protocols to dynamically determine the types of the network devices and the functions of the network devices. The network optimizer may also retrieve one or more seed files such as, but not limited to, hostname, device ID, PID, SN, IP Address, device rule, for examples, associated with the network devices. The network optimizer may utilize advanced AI clustering optimization techniques. The AI techniques can use one or more unsupervised classification algorithms such as DBSCAN or K-Mean clustering. In some embodiments, the network optimizer may use K-Mean clustering technique. The K-Mean clustering technique may be utilized to cluster the network devices into K categories or groups based on the functions of the network devices, the types of the network devices, or the seed files of the network devices. The K-Means includes adding N data points to K different clusters, where K is a parameter that needs to be specified a priori. The number of clusters, K, is one of the important parameters that need to be tuned when using K-Means. For this, a heuristic approach can be implemented, in which a Sum of Squared Distance (SSD) is plotted as a function of K. The SSD represents an error when each point in data set is represented by its corresponding cluster center. FIG. 8 shows the SSD as a function of K plotted based on a network with 6 device categories (for e.g., APs, WLAN controllers, access switches, core switches, core routers, and SD-WAN routers). As K increases, SSD decreases monotonically, and hence so does the error. While increasing K reduces the error, it may also increase an overhead incurred by the AI prediction algorithm. For this example, the heuristic searches for the plot's “elbow” point, which balances between these two conflicting objectives: reducing error and maintaining low overhead. As can be seen from FIG. 8, the value of 2 of 3 strikes a good balance between the error and the overhead.

Although a specific embodiment for the graph of the elbow selection criteria for network optimization is described above with respect to FIG. 8, any of a variety of systems and/or processes may be utilized in accordance with embodiments of the disclosure. For example, the network optimizer may dynamically optimize the number of energy management groups. The aspects described in FIG. 8 may also be interchangeable with other elements of FIGS. 1-7 and FIG. 9 as required to realize a particularly desired embodiment.

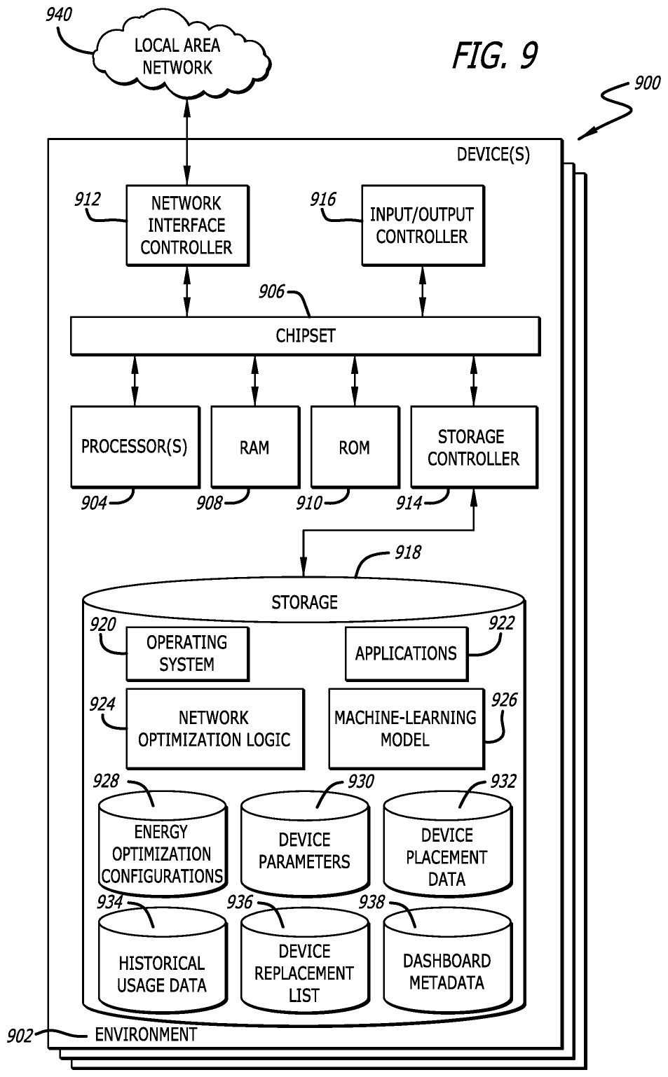

Referring to FIG. 9, a conceptual block diagram of a device 900 suitable for configuration with a network optimization logic, in accordance with various embodiments of the disclosure is shown. The embodiment of the conceptual block diagram depicted in FIG. 9 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 9 can also illustrate an access point, a switch, or a router in accordance with various embodiments of the disclosure. The device 900 may, in many non-limiting examples, correspond to physical devices or to virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, environment 902 may be a virtual environment that encompasses and executes the remaining components and resources of the device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In a number of embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 can provide an interface to a random-access memory (“RAM”) 908, which can be used as the main memory in the device 900 in some embodiments. The chipset 906 can further be configured to provide an interface to a computer-readable storage medium such as a read-only memory (“ROM”) 910 or non-volatile RAM (“NVRAM”) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Additional embodiments of the device 900 can be configured to operate in a networked environment using logical connections to remote computing devices and computer systems through a network, such as the network 940. The chipset 906 can include functionality for providing network connectivity through a network interface card (“NIC”) 912, which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for instance, store an operating system 920, applications 922, energy optimization configurations 928, device parameters 930, device placement data 932, historical usage data 934, device replacement list 936, and dashboard metadata 938 which are described in greater detail below. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. The energy optimization configurations 928 may include one or more power down times or wake-up times for the network devices in the network. The device parameters 930 can include one or more identifiers, energy parameters, or functional parameters of the network devices. The device placement data 932 may include information about placement of the network devices in the network. The historical usage data 934 can include past usage times or device utilizations of the network devices. The device replacement list 936 may include one or more replacement devices for each replaceable network device. The dashboard metadata 938 may include data associated with displaying the interactive dashboard on the device 900.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

In many more embodiments, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to device 900. Stated otherwise, some or all of the operations performed by the cloud computing network, and or any components included therein, may be performed by one or more devices 900 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In many additional embodiments, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as application 922 and transform the device 900 by specifying how the processor(s) 904 can transition between states, as described above. In some embodiments, the device 900 has access to computer-readable storage media storing computer-executable instructions which, when executed by the device 900, perform the various processes described above with regard to FIGS. 1-8. In certain embodiments, the device 900 can also include computer-readable storage media having instructions stored thereupon for performing any of the other computer-implemented operations described herein.

In many further embodiments, the device 900 may include a network optimization logic 924. The network optimization logic 924 can be configured to perform one or more of the various steps, processes, operations, and/or other methods that are described above. Often, the network optimization logic 924 can be a set of instructions stored within a non-volatile memory that, when executed by the processor(s)/controller(s) 904 can carry out these steps, etc. In some embodiments, the network optimization logic 924 may be a client application that resides on a network-connected device, such as, but not limited to, a server, switch, personal or mobile computing device in a single or distributed arrangement. In certain embodiments, the network optimization logic 924 reduces the energy consumption of the network by creating and managing one or more energy management groups in the network.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9 and can include other components that are not explicitly shown in FIG. 9 or might utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform functions described herein. The virtualization layer may generally support a virtual resource that performs at least a portion of the techniques described herein.

Finally, in numerous additional embodiments, data may be processed into a format usable by a machine-learning model 926 (e.g., feature vectors), and or other pre-processing techniques. The machine-learning (“ML”) model 926 may be any type of ML model, such as supervised models, reinforcement models, and/or unsupervised models. The ML model 926 may include one or more of linear regression models, logistic regression models, decision trees, Naïve Bayes models, neural networks, k-means cluster models, random forest models, and/or other types of ML models 926.

The ML model(s) 926 can be configured to generate inferences to make predictions or draw conclusions from data. An inference can be considered the output of a process of applying a model to new data. This can occur by learning from at least the energy optimization configurations 928, the device parameters 930, the device placement data 932, the historical usage data 934, the device replacement list 936, and the dashboard metadata 938 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 926 may be generated by human/administrator verifications or may compare predicted outcomes with actual outcomes.

Although a specific embodiment for a device suitable for configuration with a network optimization logic for carrying out the various steps, processes, methods, and operations described herein is discussed with respect to FIG. 9, any of a variety of systems and/or processes may be utilized in accordance with embodiments of the disclosure. For example, the device 900 may be in a virtual environment such as a cloud-based network administration suite, or it may be distributed across a variety of network devices or switches. The elements depicted in FIG. 9 may also be interchangeable with other elements of FIGS. 1-8 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

1. A device, comprising:
a processor;
a memory communicatively coupled to the processor; and
a network optimization logic, configured to:
discover a plurality of network devices in a network;
determine a plurality of device parameters corresponding to the plurality of network devices;
retrieve device placement data indicative of placements of the plurality of network devices within the network;
group a first set of network devices of the plurality of network devices into a first energy management group dynamically based on the device placement data and a first set of device parameters of the plurality of device parameters corresponding to the first set of network devices;
determine an energy optimization configuration for the first energy management group, wherein the energy optimization configuration is dynamically determined based on one or more changes within the network;
wherein the first set of network devices are configured to transmit a status signal indicative of switching on or switching to an operational mode; and
wherein one or more ports of the first set of network devices stays operational to receive one or more control signals.

2. The device of claim 1, wherein the network optimization logic is further configured to transmit the energy optimization configuration to the first set of network devices in the first energy management group.

3. The device of claim 2, wherein the network optimization logic is further configured to discover the plurality of network devices or transmit the energy optimization configuration to the first set of network devices by utilizing one or more network automation protocols.

4. The device of claim 3, wherein the energy optimization configuration is indicative of one or more power down times and one or more wake-up times.

5. The device of claim 4, wherein the first set of network devices switch off at the one or more power down times indicated by the energy optimization configuration, and wherein the first set of network devices switch on at the one or more wake-up times indicated by the energy optimization configuration.

6. The device of claim 1, wherein the network optimization logic is further configured to:
retrieve historical usage data for the first set of network devices; and
generate the energy optimization configuration based on the historical usage data.

7. The device of claim 1, wherein the network optimization logic is further configured to group a second set of network devices of the plurality of network devices into a second energy management group based on the device placement data and a second set of device parameters of the plurality of device parameters corresponding to the second set of network devices.

8. The device of claim 7, wherein the network optimization logic is further configured to:
determine an operational configuration of the second set of network devices; and
generate a device replacement list for the second energy management group based on the operational configuration of the second set of network devices.

9. The device of claim 8, wherein the device replacement list includes one or more replacement devices corresponding to each network device of the second set of network devices.

10. The device of claim 9, further comprising a display.

11. The device of claim 10, wherein the network optimization logic is further configured to:
generate an interactive dashboard indicative of the energy optimization configuration and the device replacement list; and
display the interactive dashboard on the display.

12. The device of claim 7, wherein the network optimization logic is further configured to:
determine one or more critical network devices of the plurality of network devices based on the plurality of device parameters and the device placement data; and
exclude the one or more critical network devices from the first energy management group or the second energy management group.

13. The device of claim 1, wherein the plurality of device parameters include one or more of:
device identifiers of the plurality of network devices,
software versions of the plurality of network devices, or
power-saving capabilities of the plurality of network devices.

14. The device of claim 1, wherein the plurality of device parameters and the device placement data are stored in corresponding plurality of network devices.

15. The device of claim 1, wherein the plurality of device parameters and the device placement data are stored in a storage device in the network.

16. A method, comprising:
discovering a plurality of network devices in a network;
determining a plurality of device parameters corresponding to the plurality of network devices;
retrieving device placement data indicative of placements of the plurality of network devices in the network;
grouping one or more network devices of the plurality of network devices into an energy management group dynamically based on the device placement data and one or more device parameters of the plurality of device parameters corresponding to the one or more network devices;
determining an energy optimization configuration for the energy management group, wherein the energy optimization configuration is dynamically determined based on one or more changes within the network; and
configuring the plurality of network devices to transmit a status signal indicative of switching to an operational mode, wherein one or more ports of the plurality of network devices stays operational to receive one or more control signals.

17. A device comprising:
a processor;
a memory communicatively coupled to the processor; and
a network optimization logic, configured to:
discover a plurality of network devices in a network;
determine a plurality of device parameters corresponding to the plurality of network devices;
retrieve device placement data indicative of placements of the plurality of network devices in the network;
group one more network devices of the plurality of network devices into one or more energy management groups dynamically based on the device placement data and the plurality of device parameters; and
determine one or more energy optimization configurations corresponding to the one or more energy management groups, wherein
one or more ports of the plurality of network devices stays operational to receive one or more control signals; and
the energy optimization configuration is dynamically determined based on one or more changes within the network.

18. The device of claim 17, wherein the network optimization logic is further configured to:
transmit the one or more energy optimization configurations to the one or more energy management groups respectively.

19. The device of claim 17, wherein the network optimization logic is further configured to:
retrieve historical usage data for an energy management group of the one or more energy management groups;
generate a power down schedule for the energy management group based on the historical usage data; and
transmit the power down schedule to the energy management group.

20. The device of claim 17, wherein the network optimization logic is further configured to:
determine an operational configuration of an energy management group of the one or more energy management groups; and
generate a device replacement list for the energy management group based on the operational configuration of the energy management group.
